(19) United States
(12) Patent Application Publication
(10) Pub. No.: US 2022/0076357 A1
(43) Pub. Date: Mar. 10, 2022

(54) CONTROLLED DECARBOXYLATION OF ACTIVE COMPOUNDS

(71) Applicant: Radient Technologies Innovations Inc., Edmonton (CA)

(72) Inventor: Steven Splinter, Edmonton (CA)

(21) Appl. No.: 17/239,083

(22) Filed: Apr. 23, 2021

Related U.S. Application Data
(63) Continuation of application No. PCT/IB2019/058959, filed on Oct. 22, 2019.
(60) Provisional application No. 62/749,565, filed on Oct. 23, 2018.

(51) Int. Cl. G06Q 50/04; B01D 11/02

(52) U.S. Cl. CPC G06Q 50/04; B01D 11/0284; B01D 2257/504; B01D 11/0292; B01D 11/0288

(57) ABSTRACT

A method of controlled decarboxylation of active compounds at various stages of biomass extraction is provided. The method involves partially or completely decarboxylating the biomass during at least two stages of biomass extractions. The stages may include, for example, decarboxylating prior to contact with the solvent, decarboxylating the biomass during the extraction process while it is in the slurry with solvent in the extractor, or decarboxylating after extraction.

### CROSS-REFERENCE TO RELATED APPLICATIONS

The present patent application is a continuation of International Application No. PCT/IB2019/058959 filed Oct. 22, 2019, which claims the priority benefit of U.S. provisional patent application No. 62/749,565 filed Oct. 23, 2018, the disclosures of which are incorporated by reference herein.

### BACKGROUND OF THE INVENTION

### 1. Field of the Invention

The present disclosure is generally related to decarboxylation of cannabis. More specifically, the present disclosure is related to controlling decarboxylation of acidic cannabinoids in cannabis at multiple stages of an extraction process.

### 2. Description of the Related Art

Cannabis is a genus belonging to the family of Cannabaceae, and has three main species Cannabis sativa, Cannabis indica, and Cannabis ruderalis. The genus is indigenous to central Asia and the Indian subcontinent. Cannabis has a long history of being used for therapeutic and recreational purposes. The importance of cannabis in therapeutics is emphasized by the ever-increasing number of research publication related to the new indications for cannabis. The term “cannabis biomass” is to be interpreted accordingly as encompassing plant material derived from one or more cannabis plants.

Cannabis biomass contains a unique class of terpeno-phenolic compounds known as cannabinoids or phytocannabinoids, which have been extensively studied since the discovery of the chemical structure of tetrahydrocannabinol (Delta-9-THC), commonly known as THC. Over 113 phytocannabinoids have been identified. Such cannabinoids are generally produced by glandular trichomes that occur on most aerial surfaces of the plant. The cannabinoids are biosynthesized in the plant in acidic forms known as acidic cannabinoids. The acidic cannabinoids may be slowly decarboxylated during drying of harvested plant material. Decarboxylation may be hastened by heating the cannabis biomass, such as when the cannabis biomass is smoked or vaporized. Alternative delivery methods such as ingesting typically require extracts of the cannabis biomass (also known as cannabis concentrates or cannabis oils). Often, cannabis extracts are formulated using any convenient pharmacologically acceptable diluents, carriers or excipients to produce a composition, often called a cannabis derivative product. In most cases, cannabis extracts and derivative products that are not intended to be combusted or vaporized, require that the acidic cannabinoids be decarboxylated into the active neutral forms.

In some cases, the raw cannabis biomass is subjected to a heating process to decarboxylate the acidic cannabinoids prior to extraction. When extracting using supercritical CO₂, for example, it is necessary to completely decarboxylate the plant material prior to extraction because the acidic cannabinoids are poorly soluble in supercritical CO₂. Subjecting the biomass to a prolonged heating process required to ensure complete decarboxylation may cause combustion, modification of the plant profile, negative effect on terpenes, or cause other undesirable effects that could lower quality or purity of a cannabis extract. For example, the process of decarboxylation of cannabis biomass can increase the amount of cannabinoids occurring as artefacts by oxidative degradation or isomerization. Further, extraction of cannabis biomass that has been subjected to a thermal decarboxylation can lead to loss of valuable compounds including terpenes. Still further, decarboxylation of cannabis biomass prior to extraction does not provide an ability to control the amount of decarboxylation reaction to a desired percentage of neutral cannabinoids and so provide extract products with varying ratios of cannabinoid acids and corresponding neutral cannabinoids. In other cases, decarboxylation may be performed by heating the mixture of solvent and biomass during the extraction process itself. Because heating must often be performed at temperatures above the boiling point of the solvent, this necessitates the use of a closed, pressurized system, which may add time and additional costs to the process. In other cases, the acidic cannabinoids may be decarboxylated after extraction and removal of the extraction solvent.

For some uses, however, there may be a need or desire to control decarboxylation of acidic cannabinoids during various stages of an extraction process. There is also a need to control the parameters of decarboxylation before, during or after extraction, or some combination.

### SUMMARY OF THE CLAIMED INVENTION

Embodiments of the present invention include systems and methods for controlling and in some cases, preventing decarboxylation of certain acidic cannabis compounds during processing. Such systems and methods may include automation of select parameters during extraction and other process steps. Such automation may further make use of artificial intelligence algorithms, thereby providing an increase in efficiency over time as the automation is continually refined based on feedback. As a result, the present systems and methods may provide for more efficient extraction and controlled decarboxylation of cannabis within specified limits or ranges. Such control may include control over certain parameters of extraction and decarboxylation using real-time sensor data and artificial intelligence to optimize the parameters of the extraction process while avoiding any undesired decarboxylation (e.g., beyond the specified limits or ranges). In some embodiments, such fine-grained control thereby provides for the ability to control decarboxylation of active compounds before, during, and after extraction.

### BRIEF DESCRIPTIONS OF THE DRAWINGS

FIG. 1 illustrates an exemplary network environment in which a system for controlling decarboxylation of active compounds during extraction may be implemented.

FIG. 2 is a flowchart illustrating an exemplary method for controlling decarboxylation of active compounds during extraction.

FIG. 3 is a flowchart illustrating an exemplary method for controlled decarboxylation analytics.

### DETAILED DESCRIPTION

Cannabis may be decarboxylated at various stages of an extraction process. For example, cannabis may be decarboxylated before even reaching the extraction system (e.g., through conventional heating or traditional drying and curing). In addition, decarboxylation can occur where the cannabis biomass is mixed with a solvent to form a slurry and subjected to heating inside of an extractor and after the extract has been separated from the slurry and the solvent removed.

Embodiments of the present invention include systems for controlling decarboxylation of active compounds to various extents and at various stages of extraction. In some embodiments, the cannabinoids may not be completely decarboxylated, leaving many cannabinoids the acidic form.

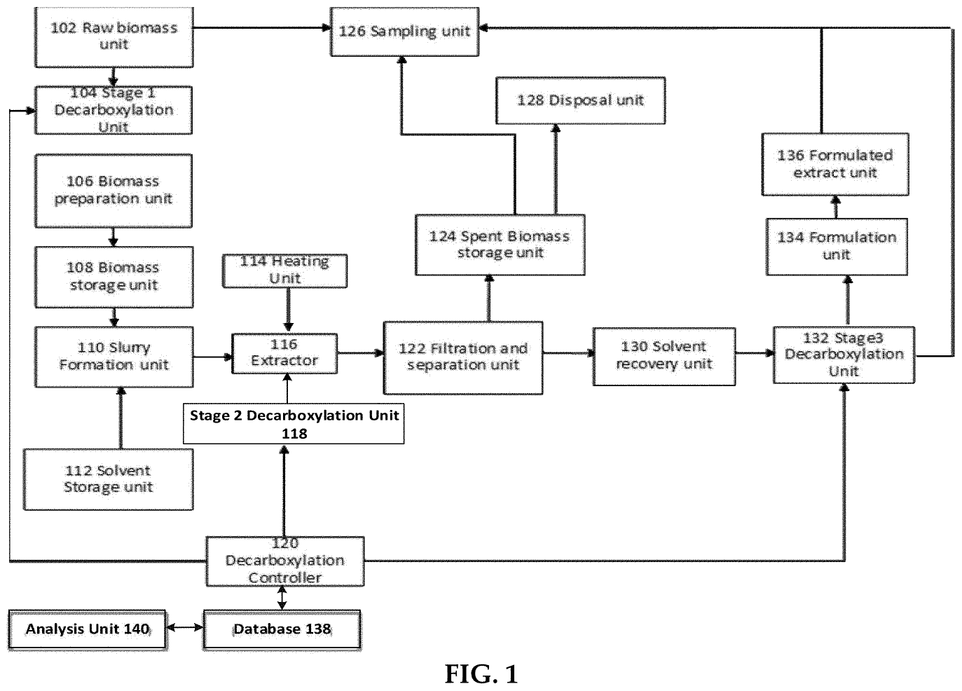

FIG. 1 illustrates an exemplary network environment in which a system for controlled decarboxylation of acidic compounds during an extraction process may be implemented. Such system may include a raw biomass unit 102 for storing the raw cannabis biomass. In some embodiments, the input biomass may have been already decarboxylated (e.g., by a grower of the biomass) to some extent.

A first stage decarboxylation unit 104 may be capable of decarboxylating the active compounds in the raw biomass, whether partially or completely. Depending on the desired attributes of an end product, the first stage decarboxylation unit 104 may decarboxylate the raw biomass provided from raw biomass unit 102 under controlled conditions. The result may be a biomass that is decarboxylated within a specified limit or range associated with first stage decarboxylation unit 104.

Biomass preparation unit 106 may prepare the raw biomass (e.g., by drying, grinding) for the next stage of processing. Biomass storage unit 108 may store the prepared biomass. Slurry formation unit 110 may form a slurry by mixing the prepared biomass with a selected solvent. A solvent storage unit 112 may store the solvent prior to incorporation into the slurry. A heating unit 114 may heat the slurry (e.g., via microwave, radiofrequency, electromagnetic, steam, etc.). A continuous flow extractor 116 may be where the slurry is exposed to heat from the heating unit 114.

A second stage decarboxylation unit 118 may be capable of decarboxylating the active compounds present in the biomass and solvent in a slurry, partially or completely in accordance with a specified limit or range. A decarboxylation controller unit 120 may be capable of controlling all stages of available decarboxylation given instructions from a user (e.g., indicative of limits or ranges of decarboxylation at each stage and consistent with desired attributes). A filtration and separation unit 122 may be provided for filtering and separating spent (extracted) biomass from the solvent and extract. A spent biomass storage unit 124 may be provided for storing the spent biomass. A sampling unit 126 may sample the biomass, extract, or both for analysis as to status and composition thereof. A disposal unit 128 may be provided for disposing of the spent biomass. Solvent recovery unit 130 may be provided for recovering solvent from the extract.

A third stage decarboxylation unit 132 may be capable of decarboxylating the active compounds that have been extracted from the biomass, whether partially or completely in accordance with specified limits or ranges after the extraction process has concluded, and the solvent has been removed. Formulation unit 134 may be provided for formulating the extract into a formulation (e.g. mixture with a medium chain triglyceride or other carrier fluid) to output a formulated extract. A database 138 may be provided for storing data related to each stage of decarboxylation, as well as results of the extraction including purity and yield, and the results of analysis of said data. An analysis unit 140 may also be provided that is capable of analyzing the results of the multi-stage decarboxylation, including its effect on the purity and yield of an extraction process.

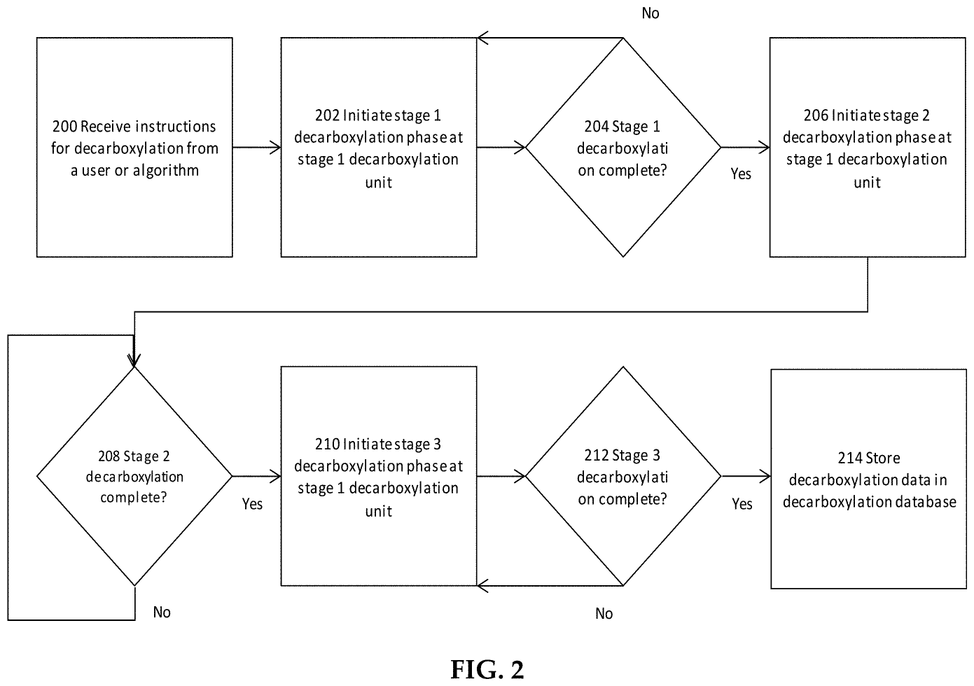

FIG. 2 is a flowchart illustrating an exemplary method for controlled decarboxylation of active compounds during extraction. Such method may be performed via execution of the decarboxylation controller 120 of FIG. 1. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The process begins with step 200 in which the decarboxylation controller 120 may receive instructions for decarboxylation from a user or algorithm. The instructions may include the percentage of the biomass to decarboxylate at one or more of the various stages (e.g., 0% at stage 1, 25% at stage 2, 50% at stage 3, etc.), where the percentage of decarboxylation is percent conversion of THCA to THC or CBDA to CBD, for example.

In step 202, the decarboxylation controller 120 may initiate stage 1 decarboxylation phase at stage 1 decarboxylation unit 104 (e.g., a specified amount of decarboxylation from 0% to 100%). In step 204, decarboxylation controller 120 may determine if stage 1 decarboxylation has been completed by polling the stage 1 decarboxylation unit 104. If decarboxylation to the specified amount is determined not to be complete, the method returns to step 202 for further decarboxylation. If decarboxylation to the specified amount is determined to be complete, the method may proceed to step 206.

In step 206, decarboxylation controller 120 may initiate stage 2 decarboxylation phase at stage 2 decarboxylation unit (e.g., a specified amount of decarboxylation from 0% to 100%). In step 208, decarboxylation controller 120 may determine if stage 2 decarboxylation has been completed by polling the stage 2 decarboxylation unit. If decarboxylation to the specified amount is determined to be complete, the decarboxylation controller 120 may initiate stage 3 decarboxylation phase at stage 3 decarboxylation unit (e.g., a specified amount of decarboxylation from 0% to 100%). In step 212, decarboxylation controller 120 may determine if Stage 3 decarboxylation has been completed by polling the stage 3 decarboxylation unit. In step 214, decarboxylation controller 120 may store decarboxylation data in the decarboxylation database 138. As such, the active compounds are decarboxylated in a controlled manner across multiple stages. Such fine-grained control over decarboxylation further allows for flexibility, efficiency, and consistency in formulating end-products based on decarboxylated active compounds.

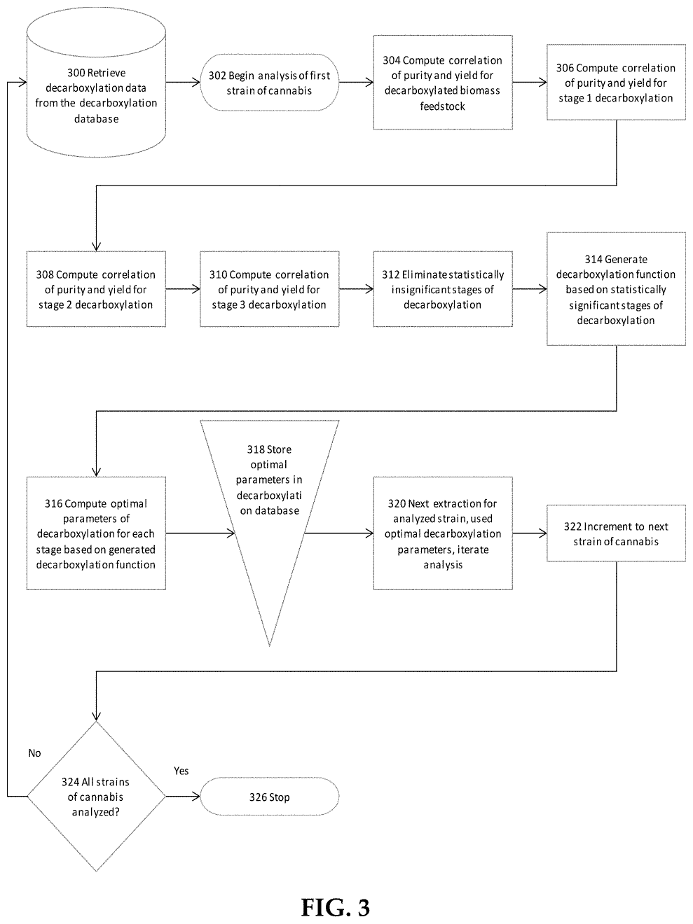

FIG. 3 is a flowchart illustrating an exemplary method for controlled decarboxylation analytics. Such method may be performed by executing the analysis unit 140 of FIG. 1. The method begins at step 300 where analysis unit 140 may retrieve decarboxylation data from the decarboxylation database 138 (e.g, data of pertaining to each stage of decarboxylation, as well as the results of purity and yield of the final extract).

In step 302, analysis unit 140 may begin analysis of first strain of cannabis (e.g., analysis for defined optimal parameters for each stage of decarboxylation for a particular strain of cannabis). In step 304, analysis unit 140 may compute correlation of purity and yield for decarboxylated biomass feedstock. Such correlation may include any statistical methods known in the art (e.g., ordinary least squares, logistic regression, Pearson's correlation coefficient, etc.). In step 306, analysis unit 140 may compute correlation of purity and yield for stage 1 decarboxylation. In step 308, analysis unit 140 may compute correlation of purity and yield for stage 2 decarboxylation. In step 310, analysis unit 140 may compute correlation of purity and yield for stage 3 decarboxylation.

In step 312, analysis unit 140 may eliminate statistically insignificant stages of decarboxylation (e.g., where the eliminated stages of decarboxylation may have an R-squared value equal to or less than 0.90). In step 314, analysis unit 140 may generate decarboxylation function based on statistically significant stages of decarboxylation. The decarboxylation function may include any of the statistically significant stages of decarboxylation, or independent variables therein, along with a correlation coefficient that describes the magnitude by which the contribute to the purity and yield of the final extract.

In step 316, analysis unit 140 may compute optimal parameters of decarboxylation for each stage based on generated decarboxylation function. The optimal parameters for each stage of decarboxylation may correspond with an independent variable of said function, and the dependent variable may reflects the optimal output of the extraction process in terms of purity and yield.

In step 318, analysis unit 140 may store optimal parameters in decarboxylation database 138. In step 312, analysis unit 140 may analyze a next extraction for strain, used optimal decarboxylation parameters, iterate analysis, etc. The optimal parameters may be updated based on the data of collected from an extraction using the previously computed optimal parameters.

In step 322, analysis unit 140 may increment to next strain of cannabis. In step 324, analysis unit 140 may determine if all strains of cannabis have been analyzed. If so, the analysis unit 140 may end its operation until additional strains or extractions may be analyzed in step 326. If not, the method may return to step 300 for further analysis.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

What is claimed is:

1. A method for controlling decarboxylation, the method comprising:
receiving instructions regarding decarboxylation of a cannabis biomass undergoing a plurality of stages of extraction, wherein the instructions specify at least one amount of decarboxylation at one of the extraction stages;
sampling the cannabis biomass during the at least one specified extraction stage, wherein a current amount of decarboxylation does not yet meet the specified amount of decarboxylation;
allowing the at least one specified extraction stage to continue until a later sample reflects that the current amount of decarboxylation does not yet meet the specified amount of decarboxylation; and
ending the at least one specified extraction stage based on the later sample, wherein the cannabis biomass is passed onto a next one of the extraction stages.

2. The method of claim 1, wherein the instructions are based on a type of cannabis biomass.

3. The method of claim 1, wherein the instructions further includes a set of parameters executable by a processing unit associated with the at least one specified extraction stage.

4. The method of claim 3, further comprising identifying the set of parameters based on a type of the cannabis biomass.

5. The method of claim 4, wherein identifying the set of parameters is based on data regarding a past cannabis biomass of the same type.

6. The method of claim 5, wherein the data regarding the past cannabis biomass includes at least one of purity and yield of a target compound.

7. The method of claim 6, wherein identifying the set of parameters is based on a correlation to at least one of the purity or yield.

8. The method of claim 5, wherein the data regarding the past cannabis biomass is stored in a decarboxylation database.

9. The method of claim 8, wherein identifying the set of parameters includes identifying the type of the cannabis biomass, and retrieving the data regarding the past cannabis biomass of the same type from the decarboxylation database.

10. A system for controlling decarboxylation, the system comprising:
a communication network interface that receives instructions regarding decarboxylation of a cannabis biomass undergoing a plurality of stages of extraction, wherein the instructions specify at least one amount of decarboxylation at one of the extraction stages;
a sampling unit that samples the cannabis biomass during the at least one specified extraction stage, wherein a current amount of decarboxylation does not yet meet the specified amount of decarboxylation; and
a processor that executes instructions stored in memory, wherein the processor executes the instructions to:
allow the at least one specified extraction stage to continue until a later sample reflects that the current amount of decarboxylation does not yet meet the specified amount of decarboxylation; and
end the at least one specified extraction stage based on the later sample, wherein the cannabis biomass is passed onto a next one of the extraction stages.

11. The system of claim 10, wherein the instructions are based on a type of cannabis biomass.

12. The system of claim 10, wherein the instructions further includes a set of parameters executable by a processing unit associated with the at least one specified extraction stage.

13. The system of claim 12, wherein the processor identifies the set of parameters based on a type of the cannabis biomass.

14. The system of claim 13, wherein the processor identifies the set of parameters based on data regarding a past cannabis biomass of the same type.

15. The system of claim 14, wherein the data regarding the past cannabis biomass includes at least one of purity and yield of a target compound.

16. The system of claim 15, wherein the processor identifies the set of parameters based on a correlation to at least one of the purity or yield.

17. The system of claim 16, wherein the data regarding the past cannabis biomass is stored in a decarboxylation database.

18. The system of claim 17, wherein the processor identifies the set of parameters by identifying the type of the cannabis biomass, and wherein the communication interface retrieves the data regarding the past cannabis biomass of the same type from the decarboxylation database.

19. A non-transitory, computer-readable storage medium, having embodied thereon a program executable by a processor to perform a method for controlling decarboxylation, the method comprising:
receiving instructions regarding decarboxylation of a cannabis biomass undergoing a plurality of stages of extraction, wherein the instructions specify at least one amount of decarboxylation at one of the extraction stages;
sampling the cannabis biomass during the at least one specified extraction stage, wherein a current amount of decarboxylation does not yet meet the specified amount of decarboxylation;
allowing the at least one specified extraction stage to continue until a later sample reflects that the current amount of decarboxylation does not yet meet the specified amount of decarboxylation; and
ending the at least one specified extraction stage based on the later sample, wherein the cannabis biomass is passed onto a next one of the extraction stages.
